(19) United States
(12) Patent Application Publication
(10) Pub. No.: US 2005/0058796 A1
(43) Pub. Date: Mar. 17, 2005

(54) Flexible tubing

(76) Inventors: Thomas Dawson Thomson, Sumner Christchurch (NZ); Purushottam Das Agrawal, Akron, OH (US)

Correspondence Address: WALKER & JOCKE, L.P.A., 231 SOUTH BROADWAY STREET, MEDINA, OH, 44256, US

(21) Appl. No.: 10/661,904

(22) Filed: Sep. 12, 2003

(51) Int. Cl. B32B 1/08

(52) U.S. Cl. 428/36.91

(57) ABSTRACT

Flexible tubing derived from laminated polymeric materials having inner and outer walls wherein the inner wall of the laminated tubing is substantially resistant to bacteria growth and consist essentially of thermoplastic silicone rubber, and the outer wall of said laminated tubing consist essentially of polymeric rubber derived from a polymeric blend comprising olefin polymers. The flexible polymeric tubing is particularly useful in aqueous systems such as tubing for milk and portable water.

### TECHNICAL FIELD

This invention relates flexible tubing for use in aqueous systems and more particularly for use in systems for collecting and distributing milk. More specifically, this invention relates to flexible elastomeric tubing having an inner wall made of bacteria resistant thermoplastic silicone rubber and an outer wall of polymeric rubber derived from polymer blends comprising olefinic polymers.

### BACKGROUND ART

Construction of automatic milking apparatus has been recognized as an important consideration in the dairy industry. Bacterial contamination of the milking machines or systems contributes to mastitis, and therefore efforts have been made in hygienic construction of the milking apparatus.

Potential habitats for bacteria include such areas as the inside of milk tubes, rubber gaskets and cracks in the various parts of milking systems. This also includes microhabitats created by microscopic surface cracks which exist in the rubber tubing. The surface cracks of conventional rubber parts e.g. tubing becomes more severe with usage. For purposes of this invention, the use of thermoplastic silicone rubber (TSR) for milk hose lines or tubing is required, inasmuch as silicone rubber tubing does not exhibit surface cracks or bacteria contamination as experienced with conventional rubber, and the habitats for bacterial propagation is greatly minimized. Therefore, the use of thermoplastic silicone rubber tubes is expected to minimize the bacteria contamination in conventional rubber tubing used in the milk industry.

### DISCLOSURE OF INVENTION

This invention relates to flexible elastomeric tubing comprising laminated polymeric materials wherein the tubing has an inner wall substantially resistant to bacteria growth consisting essentially of a thermoplastic silicone rubber with the outer wall comprising polymeric rubber derived from a polymer blend comprising olefin polymers. The polymeric rubber of the outer wall is derived from a polymeric blend comprising from about 10 to 30 parts by weight of an olefinic copolymer, 25 to 50 parts by weight of an olefin-styrene block copolymer, 25 to 50 parts by weight of a thermoplastic rubber, or as an alternative an ethylene-vinyl acetate copolymer, 2 to 15 parts by weight of a maleic anhydride-olefin copolymer and 0 to 1.0 part by weight of a phenolic resin. The flexible tubing of this invention is particularly useful for conveying aqueous liquids such as milk or water because of the resistance of the thermoplastic silicone rubber (TSR) to bacteria growth.

It is therefore an object of this invention to provide flexible tubing for conveying aqueous liquids wherein the inner wall of the tubing comprises a thermoplastic silicone rubber.

It is another object of this invention to provide flexible tubing of multi-layer construction wherein the inner layer of the tubing comprises a thermoplastic silicone rubber.

It is a further object of this invention to provide a process of conveying an aqueous liquid through flexible tubing substantially resistant to bacteria.

It is still a further object of this invention to provide flexible tubing for aqueous systems wherein the inner wall of said tubing comprises thermoplastic silicone rubber which is substantially bacteria resistant and provides sanitary conditions with the outer wall of said tubing comprising polymeric rubber derived from a polymer blend comprising olefin polymers.

These and other objects of this invention will become apparent from a further and more detailed description of the invention.

### BEST MODES FOR CARRYING OUT INVENTION

This invention relates to flexible elastomeric tubing and more specifically to tubing particularly useful in aqueous systems including the elastomeric tubing used in milking machines. The elastomeric tubing is derived from laminated polymeric materials wherein the inner wall of the tubing is substantially resistant to bacteria and consist essentially of thermoplastic silicone rubber (TSR) with the outer wall comprising a particular polymeric rubber. The polymeric rubber of the outer wall of the tubing is derived from a polymeric blend of polymers and copolymers comprising from about 10 to 30 parts by weight and preferably 15 to 25 parts by weight of an olefinic copolymer derived from lower molecular weight olefins, 25 to 50 parts by weight and preferably 35 to 40 parts by weight of a styrene-olefin block copolymer, 25 to 50 parts by weight and preferably 35 to 40 parts by weight of a particular thermoplastic rubber or as an alternative an ethylene-vinyl acetate copolymer (EVA), 2 to 15 parts by weight and preferably 4.0 to 10 parts by weight of maleic anhydride-olefinic copolymer, and 0 to 1.0 parts by weight and preferably 0.4 to 0.6 parts by weight of a phenolic resin.

The thermoplastic silicone rubber of the inner wall of the tubing is available from the Dow Corning Co. as TPSiV, and is characterized as a vulcanized silicone thermoplastic resin that can be extruded on conventional thermoplastic processing equipment in preparing laminates from which the tubing is prepared.

TPSiV materials can be extruded on conventional processing equipment. The screw L/D should be at least 24:1 with a compression ratio of 2.5:1 to 3.5:1. General-purpose screws with a feed length of 4-8 D, compression length of 8-12 D, and a metering length of 6-10 D are acceptable for the extrusion of TPSiV materials. Screws with a pin or mixing section are recommended to provide a homogenous melt. The thermoplastic silicone rubber (TPSiV) is characterized as having excellent abrasion resistance, high temperature performance, bonds with various other polymers, and has low temperature flexibility and impact resistance.

The polymeric rubber used as the outer laminate of the tubing is derived from blends of polymeric materials comprising 10 to 30 and preferably 15 to 25 parts by weight of an olefinic polymer and particularly an ethylene-octene copolymer available from the Exxon Mobil Co. as EXACT 0201. Preferred olefinic polymers used in preparing these polymeric copolymers include ethylene copolymerized with suitable monomers such as C₂-C₈ alpha olefins including propylene, butene-1,1-pentene, 4-methyl pentene-1, hexene-1 and octene-1. The preferred comonomer is octene-1.

The second polymer of the polymeric blend comprises an ethylene, propylene, or styrene polymer or copolymer formed by a polymerization reaction in the presence of a catalyst preferably a metallocene. The preferred copolymer comprises 25 to 50 and preferably 35 to 40 parts by weight of a styrene-olefinic block copolymer available from the Dow Chemical Co as VECTOR 4111. More specifically, VECTOR 4111 is a linear, pure SIS triblock copolymer with narrow molecular weight distribution. The polymer is a low styrene, low modulus copolymer. It contained <1% diblock. It is the softest pure SIS triblock and has the highest elasticity. It has outstanding melt processability and is designed for use in elastomeric films or sheets and is a highly elastomeric compound. VECTOR 4114 (diblock isoprene-styrene-isoprene-styrene) a highly elastomeric polymer can be substituted for VECTOR 4111. Further, a blend of VECTOR 4111 and 4114 will also provide an elastomeric compound. The properties of VECTOR 4111 are shown in Table I.

TABLE I

| Properties | Test Method | Unit | Typical Value |
|---|---|---|---|
| Resin Properties | | | |
| Styrene | Dexco Method | Wt. % | 18 |
| Diblock Content | Dexco Method | Wt. % | <1.0 |
| MFR⁽¹⁾ | ASTM D 1238 | G/10 min | 12 |
| Ash | ASTM D 1416 | Wt. % | 0.3 |
| Physical Properties | | | |
| Tensile Strength⁽²⁾ | ASTM D 412 | PSI | 4000 |
| 300% Modulus⁽²⁾ | ASTM D 412 | PSI | 275 |
| Elongation⁽²⁾ | ASTM D 412 | % | 1200 |
| Hardness⁽³⁾ | ASTM D 2250 | Shore A | 39 |
| Specific Gravity | ASTM D 792 | g/ee | 0.93 |
| Product Form | | | Dense Pellet |

⁽¹⁾Condition (200° C./5 kg).
⁽²⁾Typical values on compressions molded plaques, intended only as guides and should not be construed as specifications.
⁽³⁾1 sec. Dwell.

The third polymer of the polymeric blend comprises 25 to 50 and preferably 35 to 40 parts by weight of a thermoplastic rubber available as VYRAM 9000 series. Vyram rubber is a thermoplastic vulcanizate (TPV) consisting of finely divided particles of partially crosslinked rubber in a continuous matrix of thermoplastic. Thus, it has the processability of a thermoplastic, but the properties and functional performance of a rubber. In polar fluids such as water and aqueous solutions, Vyram rubber retains its properties (with low volume swell) quite adequately and is comparable to Santoprene rubber. In non-polar fluids, especially at elevated temperature, the superiority of the latter becomes apparent.

In another embodiment, SANTOPRENE can be successfully employed in place of the VYRAM rubber. These materials are proprietary compositions commercially available from Advanced Elastomer Systems of St. Louis. The materials are characterized as thermoplastic rubber in which cross-linked rubber particles are dispersed throughout a continuous matrix of thermoplastic material with the rubber particles having an average size of 1 μm and a hardness grade between about 55 Shore A and about 50 Shore D.

In another embodiment, ethylene/vinyl acetate copolymers (EVA) can be used in place of the VYRAM rubbers. These polymers are selected from ethylene vinyl acetate copolymers having a vinyl acetate percentage by weight relative to the ethylene in the range of 15-40 percent by weight. The term “ethylene-vinyl acetate copolymer” includes both the dipolymers and the terpolymers of ethylene with vinyl acetate and with carbon monoxide. Most commercial EVA dipolymers contain about 2-55 percent by weight of vinyl acetate. Terpolymers of ethylene with vinyl acetate and with carbon monoxide may contain about 18-40 percent by weight of vinyl acetate and 2-12 percent by weight of carbon monoxide. Polymers of ethylene with vinyl acetate are available from the E. I. Du Pont de Nemours and Company, under the trademark Elvax®. The terpolymers with carbon monoxide can be made according to the teachings of U.S. Pat. No. 2,495,286.

The fourth polymer of the polymeric blend comprises about 2 to 15 and preferably 4 to 10 parts by weight of a maleic anhydride-olefinic copolymer available as EXXELOR-VA 1803 from the Exxon Mobil Co. Exxelor Va. 1803 is a high flow, amorphous ethylene copolymer functionalized with maleic anhydride by reactive extrusion. Its fully saturated backbone results in outstanding thermal and oxidative stability leading to enhanced weatherability. Moreover, its amorphous nature exhibits impact resistance at very low temperatures in blends with other polymers

Properties of EXXELOR-VA 1803 are shown in Table II.

TABLE II

| | Exxon Mobile Test | | Exxelor |
|---|---|---|---|
| Property | Method (based on) | Unit | VA 1803 |
| Maleic anhydride | FTIR EPK-04 QT-02 | | High (*) |
| graft level | | | |
| Melt flow rate | ASTM D 1238 | g/10 min | 3 |
| (2.16 kg/230° C.) | | | |
| Melt flow rate (10 kg/ | ASTM D 1238 | g/10 min | 22 |
| 230° C.) | | | |
| Density | DIN 53479 | g/cm3 | 0.66 |
| Glass transition | D8C | ° C. | −57 |
| temperature (Tg) | | | |
| Volatiles | AM-S 350.03 | % | 0.15 max. |
| Color | ASTM E 313-96 | Yellowness | 25 max |
| | | Index | |
| | | Pellet | |

(*) MA level is typically in the range of 0.5 to 1.0 wt %
The values indicated in the table describe typical properties but do not constitute specification limits.

The fifth material of the polymeric blend comprises about 0 to 1.0 and preferably 0.4 to 0.6 parts by weight of phenolic resins obtained from Schenectady International Inc. as SP-1045. SP-1045 Resin is a heat reactive octylphenol-formaldehyde resin which contains methylol groups. It was specifically designed for the cure of isobutylene-Isoprene (Butyl) rubber by the resin cure system. The octyl group also makes SP-1045 Resin compatible with elastomers, and can yield products offering a wide range of properties. In addition, the methylol groups can be used as functional sites for a variety of reactions.

Other phenolic resins useful in this invention include the novalac resins. Novolac resins are described in the Encyclopedia of Polymer Science and Engineering, Volume 11, pages 45-95 (1985). Thermoplastic novolac resins are produced when a less than stoichiometric amount of formaldehyde is reacted with phenol in an acidic solution. In general, novolacs do not contain hydroxymethyl groups and will not crosslink simply by heating. Examples of the novolac resins useful include, but are not limited to, phenol-formaldehyde, resorcinol-formaldehyde, p-butyl phenol-formaldehyde, p-ethyl phenol-formaldehyde, hexyl phenol-formaldehyde, p-propyl phenol-formaldehyde, pentyl phenol-formaldehyde, p-octyl phenol-formaldehyde, p-heptyl phenol-formaldehyde, p-nonlyl phenol-formaldehyde, bisphenol-A-formaldehyde, hydroxynaphthalene formaldehyde and the alkyl (such as t-butyl) phenol modified esters of rosin. The various novolacs resins differ in their R substituted group, melting points, viscosities and other physical properties.

The flexible elastomeric tubing of this invention can be prepared by forming laminates of the thermoplastic silicone rubber (TPSiV), as the inner wall of the tube, with the polymeric rubber as the outer wall of the tube. The laminates can be made by coextrusion of these polymers and polymeric blends. The polymers are coextruded as layers directly in contact with one another, so that the resultant adhesion between layers occurs without a tie layer being needed, i.e., the coextrusion is carried out in the absence of any tie layer. When the coextruded laminate is in the form of tubing, the thickness of the layer can range from 6 to 18 mils e.g. with the conventional thickness being about 8 mils (0.2 mm).

The following are specific examples illustrating the composition and method of preparing the flexible tubing of this invention.

### EXAMPLE I

Thermoplastic elastomeric TPSiV was extruded on a 50 mm (2.0 inch), 24:1 L/D, 2.5:1 compression ratio screw into a 0.1 mm thick (0.004″) sheet. The TPSiV rubber was laminated onto the polymeric rubber derived from a polymeric blend comprising from about 20 parts by weight of an ethylene/octene copolymer, 35 parts by weight of a styrene-isoprene-styrene block copolymer, 35 parts by weight of a thermoplastic rubber (VYRAM 9201-45), 9.5 parts by weight of maleic anhydride-ethylene copolymer, and 0.5 parts by weight of a phenolic resin (SP 1045). The TPSiV and the polymeric blend were extruded on 50 mm (2.0 inch), 24:1 LD, 2.5:1 compression ratio extruder to form 4 mm (0.150 inch) thick sheet.

The conditions for the outer layer were as follows:

| FEED ZONE 1 | ZONE 2 | ZONE 3 |
|---|---|---|
| 140° C. | 160° C. | 170° C. |

| Adapter | Die |
|---|---|
| 180° C. | 180° C. |

The conditions for the inner layer were as follows:

| FEED ZONE 1 | ZONE 2 | ZONE 3 |
|---|---|---|
| 170° C. | 180° C. | 190° C. |

| Adapter | Die |
|---|---|
| 210° C. | 210° C. |

### EXAMPLE II

### Polymeric Blend

| Parts by Weight | |
|---|---|
| 20 | Ethylene/octene copolymer |
| 35 | Styrene-isoprene-styrene block copolymer |
| 35 | Ethylene/vinyl acetate copolymer |
| 9.5 | Maleic anhydride/ethylene copolymer |
| 0.5 | Phenolic resin |

### EXAMPLE III

### Polymeric Blend

| Parts by Weight | |
|---|---|
| 20 | Ethylene/octene copolymer |
| 40 | Styrene/isoprene/styrene block copolymer |
| 35 | Thermoplastic Rubber (VYRAM 9201-45) |
| 4.5 | Maleic anhydride/ethylene copolymer |
| 0.5 | Phenol/aldehyde resin |

The peel strength of the TPSiV/polymeric rubber laminates was greater than 25 PLI (pounds per linear inch). The laminated flexible tubing of this invention is substantially resistant to bacterial growth and resistant to fat due to the inner laminate of the tube of silicon rubber (TPSiV). The outer layer or laminate of polymeric rubber is resistant to puncture and has good abrasion resistance. The flexible tubing of this invention is particularly useful as bacteria resistant tubing in milking systems and machinery. The aqueous systems include, but are not limited to water tanks, cooling waters and other water systems (e.g., intake cooling water, effluent cooling water, recirculating cooling water), and various other recirculating aqueous systems.

Further modifications of this invention will occur to persons skilled in the art and all such modifications are deemed to be within the scope of the invention as defined by the appended claims.

1. Flexible tubing for aqueous systems derived from laminated polymeric materials; said tubing having inner and outer walls wherein the inner laminated wall of said tubing being substantially resistant to bacteria and consist essentially of thermoplastic silicone rubber and the outer laminated wall of said tubing consisting essentially of polymeric rubber derived from a polymeric blend comprising olefin polymers.

2. The tubing of claim 1 wherein the polymeric rubber of the outer wall of the tubing is derived from a polymeric blend comprising from about 10 to 30 parts by weight of an olefinic copolymer, 25 to 50 parts by weight of olefinic styrene block copolymer, 25 to 50 parts by weight of thermoplastic rubber, 2 to 15 parts by weight of maleic anhydride-olefinic copolymer, and 0 to 1.0 part by weight of a phenolic resin.

3. The tubing of claim 1 wherein the polymeric rubber of the outer wall of the tubing is derived from a polymeric blend comprising from about 20 parts by weight of an ethylene-octene copolymer, 40 parts by weight of styrene-isoprene-styrene block copolymer, 35 parts by weight of thermoplastic rubber, 4.5 parts by weight of maleic anhydride-ethylene copolymer, and 0.5 part by weight of phenolic resin.

4. The tubing of claim 2 wherein the olefinic copolymer is derived from olefins having 1 to 8 carbon atoms.

5. The tubing of claim 2 wherein the phenolic resin is a phenol-aldehyde resin.

6. The flexible tubing of claim 1 wherein the polymeric rubber is derived from a blend of olefinic copolymers wherein the olefins have 1 to 8 carbons.

7. The flexible tubing of claim 2 wherein the maleic anhydride-olefinic copolymer is derived from an olefin having 1 to 4 carbon atoms.

8. The flexible tubing of claim 2 wherein the olefinic-styrene block copolymer is derived from an olefin having 1 to 4 carbon atoms.

9. A process of conveying an aqueous liquid which comprises passing said liquid through flexible tubing derived from laminated polymeric materials; said tubing having inner and outer walls wherein the inner wall of said tubing is substantially resistant to bacterial growth and consist essentially of thermoplastic silicone rubber, and the outer wall of said tubing comprising a polymeric rubber derived from a polymeric blend comprising olefin polymers.

10. The process of claim 9 wherein the polymeric rubber of the outer wall of said tubing is derived from a polymeric blend comprising from about 10 to 30 parts by weight of an olefinic copolymer, 25 to 50 parts by weight of an olefinic-styrene block copolymer, 25 to 50 parts by weight of thermoplastic rubber, 2 to 15 parts by weight of maleic anhydride-olefinic copolymer, and 0 to 1.0 part by weight of phenolic resin.

11. The process of claim 10 wherein the olefinic copolymer is derived from olefins having 1 to 8 carbon atoms.

12. The process of claim 10 wherein the polymeric blend comprises about 20 parts by weight of an ethylene-octene copolymer, 40 parts by weight of styrene-isoprene-styrene block copolymer, 35 parts by weight of thermoplastic rubber, 4.5 parts by weight of maleic anhydride-ethylene copolymer, and 0.5 part by weight of a phenolic resin.

13. The process of claim 9 wherein the aqueous liquid is milk.

14. The process of claim 9 wherein the aqueous liquid is portable water.
